(19) United States
(12) Patent Application Publication
(10) Pub. No.: US 2011/0319075 A1
(43) Pub. Date: Dec. 29, 2011

(54) UNIVERSAL MOBILE MANAGER INTERWORKING FOR SHORT MESSAGE SERVICE FEATURE PARITY

(76) Inventors: ALOK SHARMA, Lisle, IL (US); Yigang Cai, Naperville, IL (US)

(21) Appl. No.: 12/823,371

(22) Filed: Jun. 25, 2010

(51) Int. Cl. H04W 4/12

(52) U.S. Cl. 455/432.2; 455/466

(57) ABSTRACT

The present invention provides a method that is implemented at a mobility management entity. One embodiment of the method includes converting a short message service (SMS) message from a first format to one or more second formats when one or more user profiles stored in a database indicate that one or more destinations of the SMS message use the second format(s).

### CROSS REFERENCE TO RELATED APPLICATIONS

This application is related to U.S. patent application ______, entitled “UNIVERSAL MOBILE MANAGER INTERWORKING TO SUPPORT GLOBAL ROAMDING,” filed Jun. 25, 2010.

### BACKGROUND OF THE INVENTION

1. Field of the Invention

This invention relates generally to communication systems, and, more particularly, to wireless communication systems.

2. Description of the Related Art

Short Message Service (SMS) is a communication service component that supports the exchange of short text messages between mobile phone devices. Initial acceptance and usage of SMS was slow and few users took advantage of the service. However, usage of SMS has since exploded in virtually every market around the world. As of 2008 SMS text messaging was the most widely used data application in the world, with an estimated 2.4 billion active users, or an estimated 74% of all mobile phone subscribers. In 2008, an estimated 4.1 trillion SMS text messages were sent. Clearly SMS has become a massive commercial industry that had an estimated worth of over 81 billion dollars globally as of 2006. The global average price for an SMS message is 0.11 USD, while the cost to providers approaches zero. Mobile networks charge each other so-called interconnect fees of at least 0.04 USD when connecting between different phone networks

The SMS service and protocols were originally defined as part of the Global System for Mobile Communications (GSM) series of standards in 1985 as a means of sending messages of up to 160 characters to and from GSM mobile handsets. Since then, support for the service has expanded to include other mobile technologies such as ANSI CDMA networks and Digital AMPS, as well as satellite and landline networks. Most SMS messages are mobile-to-mobile text messages, though the standard supports other types of broadcast messaging as well. Thus, despite its origins in connection with GSM, the term SMS is now used as a synonym for all types of short text messaging, as well as the user activity itself, in many parts of the world.

The evolution of communication networks that implement different standards and/or protocols and the advent of dual and multiple access mobile registration has led to a proliferation of different SMS formats and/or protocols. For example, the SMS message format used by 2G CDMA networks differs from the format used by 4G eHRPD networks. These networks may also use different encoding formats to encode the SMS messages for transmission through the network. In the current heterogeneous network environment, users may therefore encounter second-generation (2G) systems such as GSM and CDMA, third-generation (3G) systems such as UMTS and EV-DO, fourth generation systems such as LTE, 3GPP, 3GPP2, and WiMAX, as well as other legacy, current, and yet to be developed systems and/or protocols. Moreover, subscribers may utilize virtual handsets that can be implemented in different physical equipment such as a mobile unit, a virtual phone on a desktop or laptop computer, and the like. Different physical equipment may also expect or require that SMS messages be formed and/or encoded according to different formats.

The diversity of SMS message formats may disrupt or interfere with the seamless experience expected by roaming users. Conventional wireless communication systems do not support conversion between the different SMS formats. GSM systems expect to transmit SMS messages between mobile units within the GSM system according to GSM formats, UMTS systems expect transmit SMS messages between mobile units within the UMTS system according to UMTS formats, and so on. Users that roam between the different networks may therefore experience delays and/or interruptions in SMS service. Similar delays and/or disruptions may also occur when virtual phone users switch from one type of physical equipment to another, e.g., when the user arrives at work and switches their SMS connection from a mobile phone to a virtual phone application running on a desktop computer.

In some cases service providers may support limited conversion between predetermined portions of different networks. For example, if a service provider that operates a GSM system knows that a large number of users typically roam to UMTS networks and have requested support for SMS while roaming, the service provider may pre-negotiate a service that converts SMS messages between the GSM and UMTS formats. However, these pre-negotiated agreements simply use an interface that converts SMS messages between the two predetermined formats. The conversion is further limited to SMS messages that are communicated between the service provider and the service providers specified in the pre-negotiated agreement. Limited conversion is not user-aware and is unable to determine when a particular user requires conversion between any two standards or formats. For example, the interfaces used for limited conversion cannot determine that a particular user has moved from the GSM network into the UMTS network and requires GSM-UMTS conversion of SMS messages. Consequently, conventional limited conversion based on pre-negotiated agreements does not support dynamic conversion of SMS messages on a user-by-user basis.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for implementation at a mobility management entity. One embodiment of the method includes converting a short message service (SMS) message from a first format to one or more second formats when one or more user profiles stored in a database indicate that one or more destinations of the SMS message use the second format(s).

In another embodiment, a method is provided for implementation at a mobility management entity. Embodiments of this method include accessing a short message service (SMS) message that conforms to a first format and is associated with a first user and accessing a profile for the first user. The profile is stored in a database associated with the mobility management entity. The method also includes determining whether the SMS message is to be converted from the first format to a second format based on the profile and converting the SMS message to the second format when the profile indicates that the SMS message is to be converted.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 shows one exemplary embodiment of a wireless communication system;

FIG. 2 shows one alternative exemplary embodiment of a wireless communication system;

FIG. 3 conceptually illustrates one exemplary embodiment of a user profile that may be stored in a user profile database;

FIG. 4 conceptually illustrates one exemplary embodiment of a universal mobility manager that supports integrated home location register and home subscription servers;

FIG. 5 conceptually illustrates an exemplary embodiment of a network architecture that implements a common operation interface;

FIG. 6 conceptually illustrates one exemplary embodiment of the message flow used to support high-level protocol independent common operations;

FIG. 7 conceptually illustrates one exemplary embodiment of a message flow for delivery of a mobile-originated SMS message;

FIG. 8 conceptually illustrates one exemplary embodiment of a message flow for delivery of a mobile-terminated SMS message;

FIG. 9 conceptually illustrates one exemplary embodiment of a message flow for delivery of a mobile-terminated SMS message to multiple destinations in multiple networks;

FIG. 10 conceptually illustrates one exemplary embodiment of a message flow that can be used to perform terminal status updates and alert short message service centers, e.g., during circuit roaming;

FIG. 11 conceptually illustrates one exemplary embodiment of a message flow that can be used to perform terminal status updates and alert short message service centers, e.g., during IMS roaming; and

FIG. 12 conceptually illustrates one exemplary embodiment of a call flow for delivering a message waiting indicator using an SMS message.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

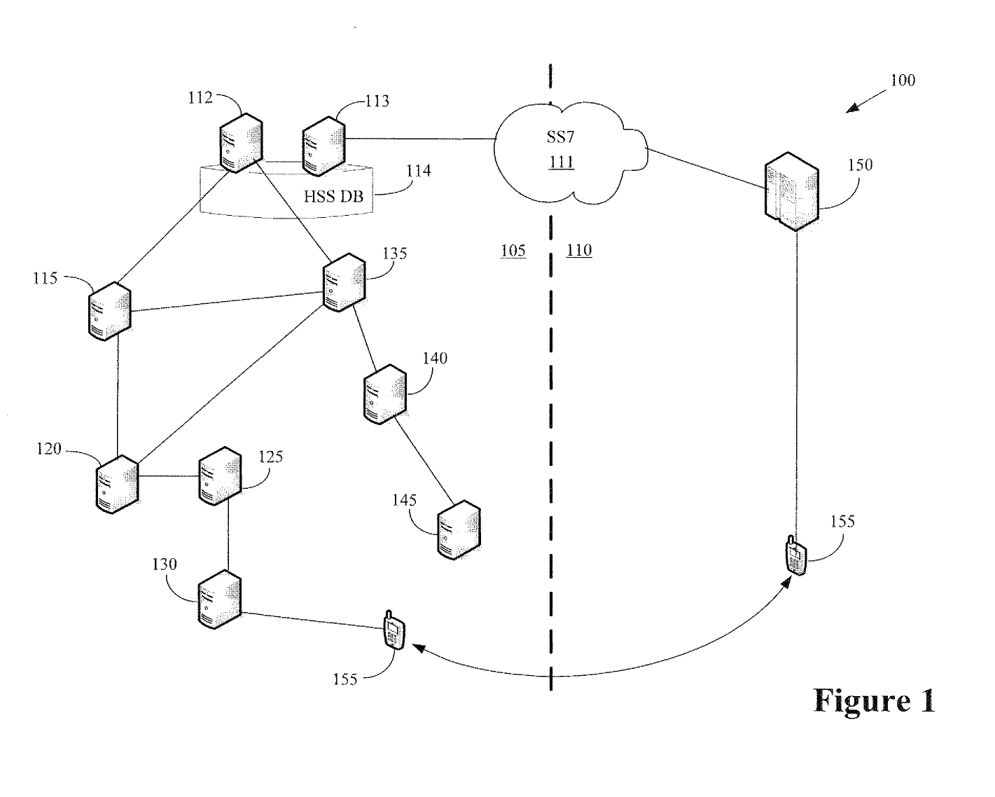

FIG. 1 shows one exemplary embodiment of a wireless communication system 100 that supports a dual mode mobile roaming between an Internet Protocol (IP) Multimedia Subsystem/Long Term Evolution (IMS/LTE) network 105 and a Code Division Multiple Access/Global System for Mobile communication (CDMA/GSM) circuit-switched network 110. The networks 105, 110 can communicate over an interface 111 that operates according to the well-known SS7 protocol.

The network 105 includes a home location register 112 and a home subscriber server 113 that can access profiles stored in a database 114. A Home Location Register (HLR) is the main database of permanent subscriber information for a mobile network. The HLR is an integral component of CDMA (code division multiple access), TDMA (time division multiple access), and GSM (Global System for Mobile communications) networks. Each subscriber's home carrier maintains an HLR (or the network operator where the user initiated the call) and the HLR contains pertinent user information, including address, account status, and preferences. The Home Subscriber Server (HSS), or User Profile Server Function (UPSF), is a master user database that supports the IMS network 105 entities that actually handle calls. It contains the subscription-related information (subscriber profiles), performs authentication and authorization of the user, and can provide information about the subscriber's location and IP information. It is similar to the GSM Home Location Register (HLR) and Authentication Centre (AUC).

The network 105 also includes a short message service center (SMSC) 115 and call session control functions including a serving call session control function (S-CSCF) 120 and a proxy call session control function (P-CSCF) 125. The P-CSCF 125 is responsible for interfacing directly with transport plane components and is the first point of signaling within IMS for any end-point. As the name implies, the P-CSCF 125 is a proxy for SIP messages from end-points to the rest of the IMS network. The S-CSCF 120 is responsible for interfacing with the Application Servers (AS) in the Application Plane. Upon receiving a registration request SIP message from an Interrogating-CSCF (not shown), the S-CSCF 120 can query the HSS 113 via Diameter protocol to register the terminal as being currently served by itself. The P-CSCF 125 communicates with a packet gateway 130.

Communication of short messages through the network 105 can be coordinated by a short message serving center gateway (SMS-GW) 135. For example, the network 105 may support a short message service (SMS) for transmitting short messages using the Mobile Application Part (MAP) of the SS7 protocol. Messages are sent with the MAP operations that support mobile-originated messages (e.g., SMS messages that are originated by a mobile unit) and/or mobile-terminated messages. (e.g., SMS messages terminated at a receiving mobile unit). In one embodiment, the payload length of an SMS message may be limited by the constraints of the signaling protocol to 140 octets (140 octets=140*8 bits=1120 bits). Larger amounts of content can be sent using multiple SMS messages that must be reassembled upon reception, e.g., using header information in the messages. Alternatively, other SMS protocols may allow different message sizes and/or payload lengths. The SMS-GW 135 also communicates with a short message peer-to-peer gateway 140 and an over-the-air server (OTA) 145. The Short Message Peer-to-Peer (SMPP) protocol used by the gateway 140 is a telecommunications industry protocol for exchanging SMS messages between SMS peer entities such as short message service centers.

The network 110 includes a GSM mobile switching center 150 that can interface with the network 105 over the SS7 interface 111. The mobile switching center 150 operates switching functions for the mobile units within its jurisdiction and supports interfaces between the mobile network 110 and other fixed or mobile networks such as the network 105. Exemplary functionality implemented in the mobile switching center 150 includes management of mobile locations, call switching, handover of mobile terminals between base station controllers and the network 110, resource management, and interworking with network databases such as home location registers, the visitor location registers, and authentication centers in the network 110.

Mobile unit 155 is a dual-mode or multiple-mode device is capable of communicating with either of the networks 105, 110. The mobile unit 155 may therefore roam between the networks 105, 110 and hand off between base stations and/or access points that provide wireless connectivity to the networks 105, 110. The mobile unit 155 also supports mobile-originated SMS messages and/or mobile-terminated SMS messages. Users of the mobile unit 155 therefore expect seamless SMS messaging regardless of the location of the mobile unit 155. However, the networks 105, 110 may use different formats for the SMS messages and may encode the SMS messages using different in coding formats. Sent or received SMS messages should therefore be converted into the appropriate format for delivery. However, conventional networks 105, 110 may not include functionality that is able to convert SMS messages between the different formats. The SMS-GW 135 may not support protocol conversion or may only support limited conversion according to pre-negotiated agreements. Some SMS-GWs may escalate the SMS to an Inter Carrier SMS gateway (IC GW) which can convert the SMS to the appropriate format and forward it, however, IC GW do not typically support dynamic registered subscribers.

The SMS-GW 135 does not typically support conversion for subscribers that dynamically roam between networks at least in part because of the difficulty in determining the location of the mobile terminal and the appropriate format conversions in a dynamically changing environment. For example, the SMS GW 135 has to query both the HSS 112 and the 3GPP HLR 113 in order to determine the mobile destination network. In some cases the HSS 112 and HLR 113 may not know whether the mobile has registered in the network 110 and so an additional set of messages may be required to determine if the mobile destination network is the network 110. The number of messages used to determine the mobile destination network therefore scales approximately in proportion to the number of types of networks that are supported by the mobile unit 155. For example, if a particular mobile destination is a multi-mode device, an interworking function may have to exchange a pair of messages with home location registers (or similar entities) to retrieve subscriber information/states from each network that is supported by the multi-mode mobile device. Once the destination has been located, another pair of messages can be used to deliver the SMS message.

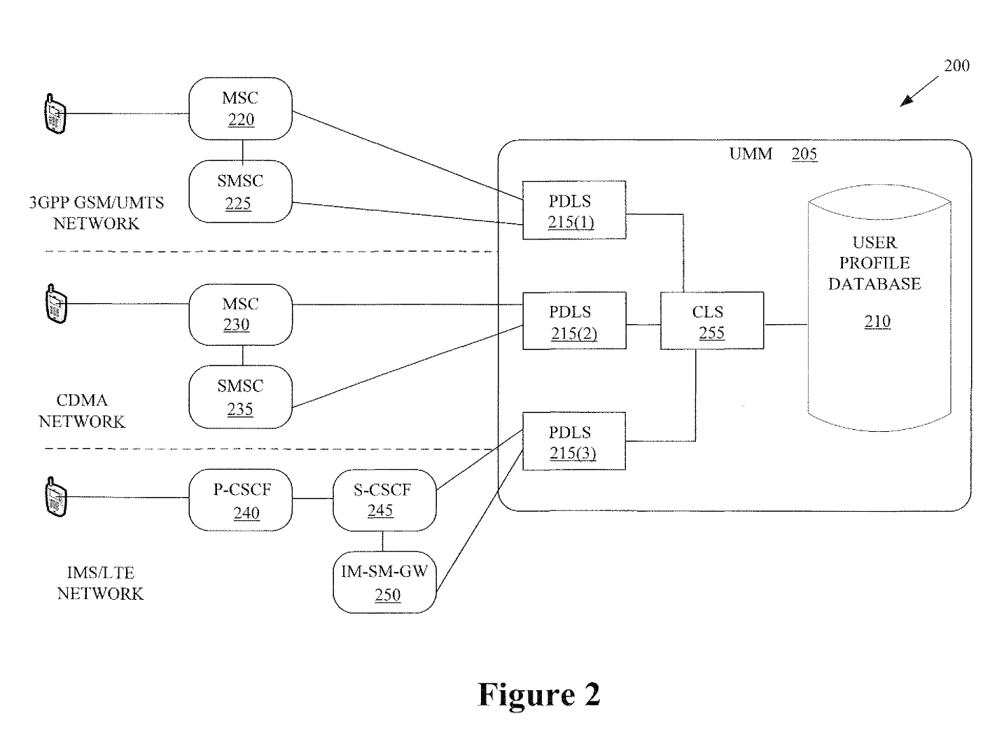

FIG. 2 conceptually illustrates an alternative exemplary embodiment of a wireless communication system 200. In the illustrated embodiment, the wireless communication system 200 includes a centralized mobility management entity that is referred to herein as a Universal Mobility Manager (UMM) 205. The UMM 205 provides interworking functionality by supporting interfaces for communication with short messaging systems in different types of networks that may operate according to different standards and/or protocols and may therefore use different packet formats and/or encoding formats for SMS messages. Profile information stored in the UMM 205 allows this entity to detect the current format of received SMS messages and to decide whether the received SMS messages need to be converted to a different format because they are going to be conveyed into a different type of network. The UMM 205 can also perform the format conversion of the SMS message and use an appropriate interface to communicate the converted SMS message to the appropriate network. The wireless communication system 200 therefore supports SMS feature parity between various networks of different types. The number of messages and/or signaling load needed to deliver SMS messages may be reduced by implementing the UMM 205 at least in part because the location and presence information for multiple network types can be stored in a single location. Gateways therefore do not need to exchange a separate set of messages with each network to determine how to deliver the SMS message.

In the illustrated embodiment, the UMM 205 includes a user profile database 210 for storing profiles associated with users that are registered in the networks that are supported by the UMM 205. User profiles may store parameters used by the user for sending and/or receiving SMS messages. The user can update the information in their profile, e.g., using interfaces provided by the communication devices and/or using a Web interface. The user profiles can also be updated using information provided by one or more networks, e.g., by downloading subscriber information, protocol presence information, and the like from the network. The user profiles can also be updated or modified dynamically in response to changes in the user's location, presence status, and/or activity status. For example, the user profiles can be modified to indicate that the user has moved into a different type of network or that a dormant user has become active. For another example, some users may use different devices and/or screens for receiving SMS messages and the presence status associated with the different devices and/or screens may be modified in response to the user turning on and/or turning off the devices and/or screens.

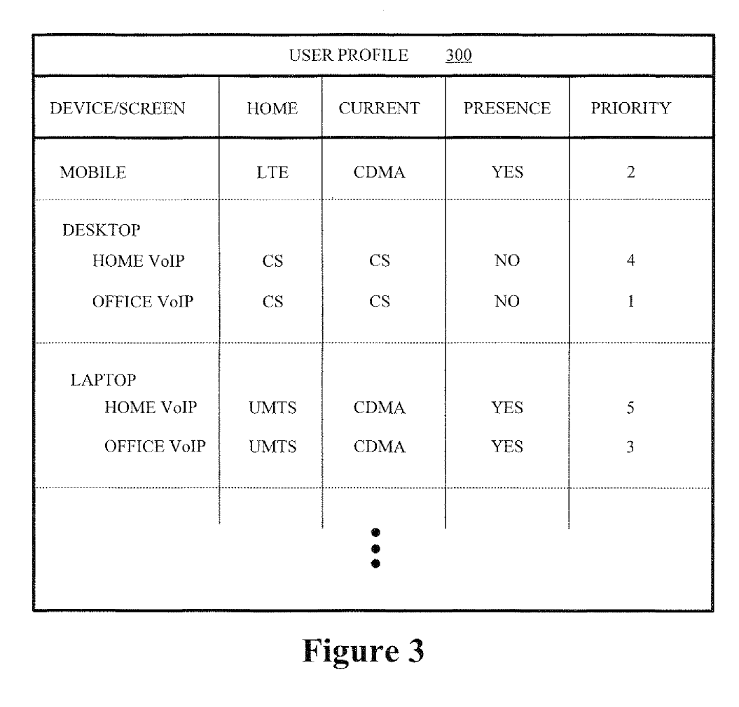

FIG. 3 conceptually illustrates one exemplary embodiment of a user profile 300 that may be stored in a user profile database such as the database 210 depicted in FIG. 2. In the illustrated embodiment, the user profile 300 indicates that the user has three devices for receiving SMS messages: a mobile unit, a desktop computer, and a laptop computer. The user profile 300 further indicates that the desktop and the laptop both support two different screens for sending and/or receiving SMS messages: a home voice over IP (VoIP) screen and an office VoIP screen. The two VoIP screen can be implemented as virtual phones on the same physical device and may use different phone numbers. The devices and/or screens indicated in the user profile 300 can be modified. For example, if the user purchases a new mobile unit that can be used to send or receive SMS messages, the user may modify the user profile to add a new device. Users may also remove the devices and/or screens from the user profile when these devices are not being used for sending and/or receiving SMS messages. The devices and screens shown in the user profile 300 can support mobile-originated SMS messages and mobile-terminated SMS messages. However, persons of ordinary skill in the art having benefit of the present disclosure should appreciate that other embodiments of the user profile 300 may include devices and/or screens that only support one or the other type of SMS messaging.

The user profile 300 includes parameters that indicate the type of the home network for each of the devices and/or screens. For example, the home network for the mobile unit is an LTE network and the home network for the laptop is a UMTS network. The user profile 300 also includes parameters that indicate the type of the current network being used by the device and/or screen. In the illustrated embodiment, the user has roamed (while carrying the mobile unit and laptop) from the home network into a CDMA network. Consequently, the current network for the mobile and the laptop is the CDMA network and the user profile 300 has been dynamically updated (e.g., in response to handover of the mobile and the laptop to the CDMA network) to indicate the change in the current network. The desktop is connected to a network by a wired circuit switched connection. The desktop is fixed and has not roamed into the CDMA network.

A presence parameter is used to indicate whether a particular device and/or screen is present and therefore available to send and/or receive SMS messages. In the illustrated embodiment, the mobile and laptop have roamed to the CDMA network and these devices are available for sending and/or receiving SMS messages. The presence parameter in the user profile 300 is therefore set to “Yes” for these devices. The user has turned off the desktop computer prior to roaming into the different network and so the presence parameter for the desktop is set to “No.” The presence parameters can be set or modified manually by the user and automatically/dynamically in response to the device, screen, and/or network detecting that the device and/or screen is present or absent.

Users may also specify a priority for sending and/or receiving SMS messages using the different devices and/or screens. In the illustrated embodiment, the user has given the office VoIP screen first priority for receiving SMS messages to indicate that the system should first attempt to deliver SMS messages to the screen when the screen is available or present. If the screen is not available or present, the system may then attempt to deliver the SMS message to other devices and/or screens having lower priorities. For example, the user has given the mobile device second priority and since this device is present, the system may deliver SMS messages to the mobile device when the desktop office VoIP screen is not present. If forking is supported by the system, SMS messages may be delivered to more than one device and/or screen associated with the user. For example, the system may deliver the SMS message to the two highest priority devices and/or screens that are present when the SMS message is to be delivered.

Referring back to FIG. 2, the UMM 205 includes various interfaces 215 (1-3) with different networks. In the illustrated embodiment, the interfaces 215 are referred to as protocol dependent logic servers (PDLS) 215 because they may implement protocol specific logic. One type of PDLS is implemented in the UMM 205 for each of the protocols that are supported. Exemplary protocols include UMTS PDLS, ANSI41 PDLS, SIP PDLS, Radius PDLS, and the like. In the illustrated embodiment, the UMM 205 includes an interface 215(1) to an MSC 220 and a SMSC 225 in a 3GPP GSM/UMTS network, an interface 215(2) to an MSC 230 and a SMSC 235 in a CDMA network, and an interface 215(3) to a P-CSCF 240, S-CSCF 245, and a gateway 250 in an IMS/LTE network. However, persons of ordinary skill in the art should appreciate that this embodiment is intended to be illustrative and not to limit the UMM 205 to interfacing with these particular types of networks. Each PDLS 215 takes advantage of the core mobility management provided by a core logic server 255 through an interface that is independent of the particular network protocols. Each PDLS 215 includes the necessary logic to accomplish requests received from its clients (VLR, SGSN, SIP proxy, RADIUS client, and so on). Each PDLS 215 may also download user profile information related to the corresponding protocol via DBCOM interface.

The core logic server 255 encapsulates core mobility management and HSS/HLR logic, which can be shared across protocols. The CLS 255 may provide the PDLS 215 with an interface that is independent of the particular network protocols. This interface is referred to herein as the Common Operation (COPS) interface. The interfaces 215 may therefore receive SMS messages in the formats used by the corresponding networks and then use the information in the SMS messages to form queries to the CLS 255 and/or the database 210. The queries can be formed according to the requirements of the COPS interface. The CLS 255 may download multi-protocol user profile information to populate the user profiles.

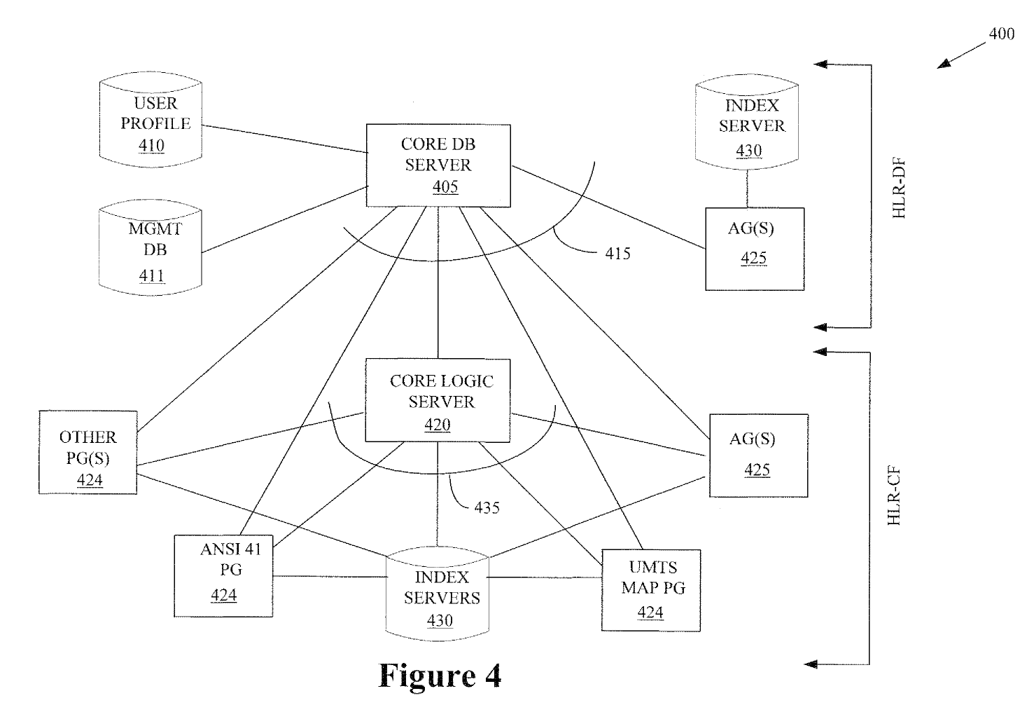

FIG. 4 conceptually illustrates one exemplary embodiment of a universal mobility manager 400 that supports integrated home location register and home subscription servers. In the illustrated embodiment, the universal mobility manager 400 can be conceptually divided into a portion that supports the home location register data functions (HLR-DF) and a portion that supports the home location register control functions (HLR-CF). The data function portion includes a core database server (CDS) 405 that manages the integrated user profile database 410 and the management database server 411. The core database server 405 also provides a database access interface 415 for other elements in the universal mobility manager 400. The core database server 405 therefore defines the data view common across protocols as well as that specific to each protocol. Core logic servers 420 are deployed in the control function portion of the universal mobility manager 400. The core logic server 420 provides protocol dependent logic servers 424 and/or application gateways 425 with the COPS interface 435. In one embodiment, the core logic servers 420 can download multi-protocol user profile information from the core database server 405.

The universal mobility manager 400 may also implement one or more application gateways 425 may be associated with different network types. The application gateways 425 may include functionality that is similar to a protocol dependent logic server, except that application gateways 425 do not deal with communication protocols, but with application protocols. For example, an application gateway 425 can support Lightweight Directory Access Protocol (LDAP) for general subscriber database access, http for end-user's web-based database access, PARLAY for new location-based service system, and so on. One or more index servers 430 may also be included in the universal mobility manager 400. Index servers 430 are used to locate an HSS/HLR-DF/CDS instance that includes user profile information of a user in question. Each index server 430 maintains a mapping table to an instance identifier from various types of user database keys employed by different protocols. Exemplary identifiers that can be used to locate user profile instances include, but are not limited to, well-known identifiers such as IMSI, MSISDN, MIN, MDN, SIP URL, and a RADIUS/DIAMETER user name. Index servers 430 accept mapping retrieval requests for CLS/PDLS/AG to find a correct HSS/HLR-DF/CDS instance. The index server 430 can then query (or provide an interface for queries from other entities) the located instance to gather information about the associated user. Each index server 430 also accepts mapping updates or erasure requests from a provisioning system to update a mapping entry, and the update can be propagated to all replica of the instance.

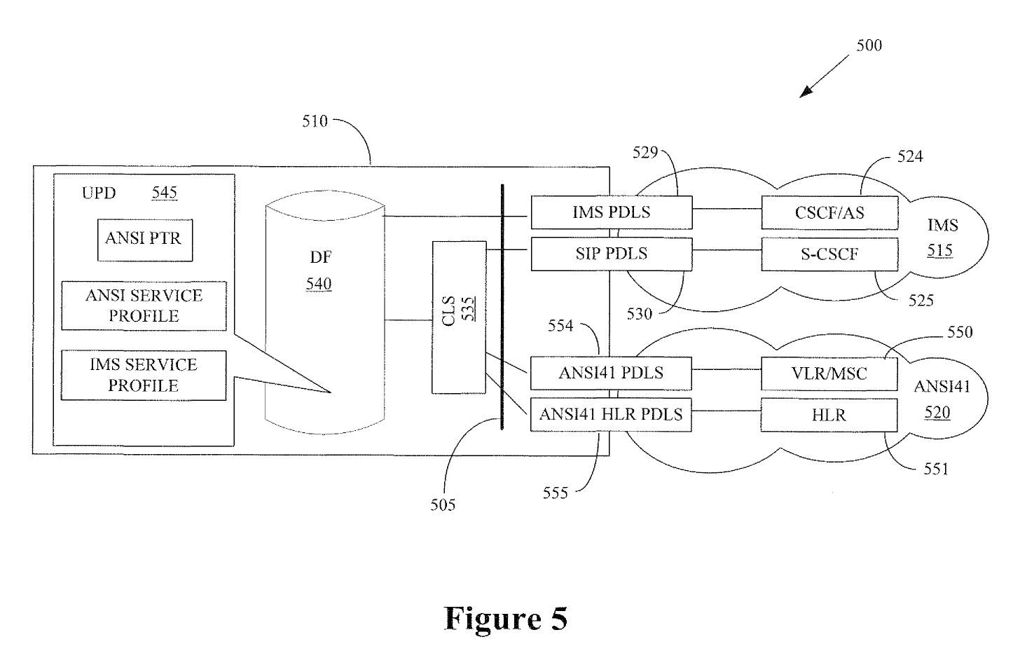

FIG. 5 conceptually illustrates an exemplary embodiment of a network architecture 500 that implements the COPS interface 505. In the illustrated embodiment, the interface 505 is implemented in a universal mobility manager 510 that is configured to coordinate the communication of SMS messages between an IMS network 515 and an ANSI41 network 520. Persons of ordinary skill in the art should appreciate that the embodiment shown in FIG. 5 is intended to be illustrative and not to limit the claimed subject matter. For example, in alternative embodiments the architecture 500 may be generalized to provide support for additional networks and/or additional network types.

In the illustrated embodiment, CSCF 524 and application server entities 525 in the IMS network 515 can exchange SMS messages with the protocol dependent logic server interfaces 529, 530 that are implemented in the manager 510. The SMS messages exchanged between the CSCF(s) 525 and the interfaces 530 are formatted according to the SMS formats used by the IMS network 515. The interfaces 530 also communicate using these SMS formats and so the interfaces 530 can extract or utilize information in the SMS messages to gather user profile information for users associated with the SMS messages by communicating with the core logic server 535 over the COPS interface 505. For example, the interfaces 530 can form database queries that are transmitted to the core logic server 535 and then onto the database function 540. Alternatively, the interfaces 530 may send the queries directly to the database function 540. The queries can be used to locate a user profile 545 that, in the illustrated embodiment, includes a pointer (ANSI PTR) that indicates that the user is currently associated with the ANSI network 520 and service profiles for both the ANSI network 520 and the IMS network 515.

A visitor location register/mobile switching center (VLR/MSC) 550 and a home location register 551 in the ANSI network 520 can exchange SMS messages with the protocol dependent logic server interfaces 554, 555. These SMS messages are formatted according to the SMS formats used by the ANSI network 520. The interfaces 554, 555 may use information in these messages to query the database function 540 and/or to communicate with the core logic server 535 over the COPS interface 505.

The core logic server 535 includes functionality to convert SMS messages between the formats used by the IMS network 515 and formats used in the ANSI network 520. In the illustrated embodiment, a user associated with the SMS message is currently communicating via the ANSI network 520, as indicated by the ANSI pointer in the user profile 545. For example, the SMS message may be a mobile-originated message transmitted by a user that is visiting the ANSI network 520 from its home IMS network 515. The core logic server 535 may therefore convert the SMS message from the ANSI format to the IMS format before the SMS message is transmitted to the IMS network 515 via the interfaces 529, 530. For another example, the SMS message may be a mobile-terminated message that is received from the IMS network 515 and is destined for the user in the ANSI network 520. The core logic server 535 may therefore convert the format of the SMS message from the IMS format to the ANSI format before conveying the converted SMS message to the ANSI network 520 via the interfaces 554, 555.

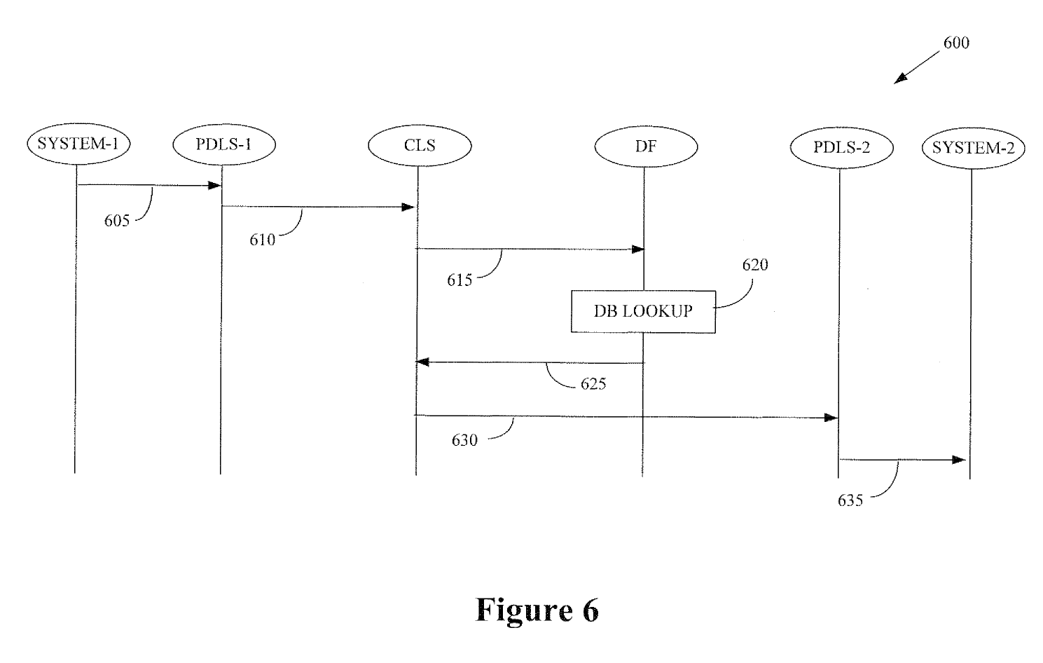

FIG. 6 conceptually illustrates one exemplary embodiment of the message flow 600 used to support high-level protocol independent common operations over the COPS interface. In the illustrated embodiment, the message flow 600 begins when an originating system (SYSTEM-1) transmits (at 605) a message to a protocol dependent location server (PDLS-1) requesting location of a destination entity associated with an SMS message. Exemplary messages include an ANSI41 locreq message, a UMTS SRI message, a SIP invite message, and the like. PDLS-1 transmits (610) a message including a database query over the COPS interface to the core logic server (CLS), which forwards (615) the database query to the database function (DF). The database function uses the query to perform (at 620) a database lookup to locate a user profile indicated in the query. In the illustrated embodiment, the results of the query indicate that the destination entity is in a different system (SYSTEM-2).

The database function returns (at 625) the location information to the core logic server so that the core logic server can use this information to determine whether to convert the SMS message to a different format. In the illustrated embodiment, the SMS message is to be transmitted to a different system and so the core logic server performs a conversion of the SMS message from the format used by the first system to the format used by the second system. The converted message is then transmitted (at 630) to the protocol dependent location server (PDLS-2) that interfaces with the second system. PDLS-2 then forwards (at 635) the converted SMS message to SYSTEM-2.

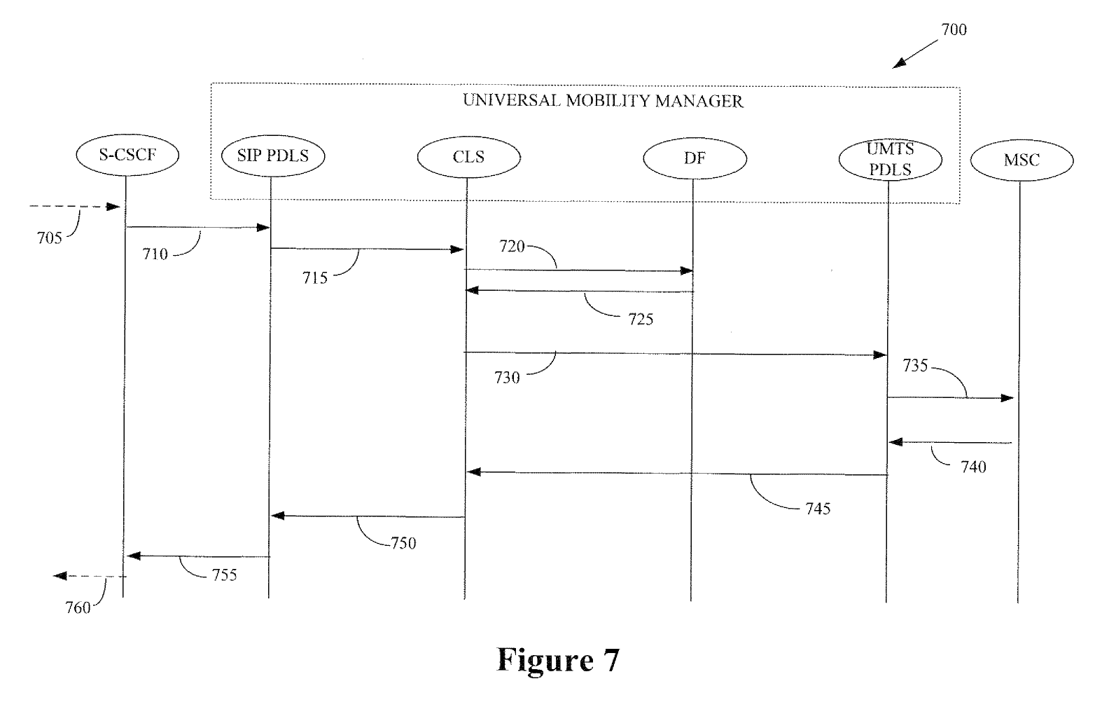

FIG. 7 conceptually illustrates one exemplary embodiment of a message flow 700 for delivery of a mobile-originated SMS message. In the illustrated embodiment, the mobile terminal that originates the SMS message is a dual or multimode terminal that is capable of communicating with two or more different types of networks including IMS networks, ANSI41 networks, LTE networks, UMTS networks, and the like. The mobile unit's home network may be an ANSI41 network or a UMTS network and the mobile unit is therefore associated with a home SMS Center located in the ANSI41 network or the UMTS network. Prior to originating the SMS message, the mobile unit roams into a different type of network such as an IMS network. Consequently, the mobile unit originates the SMS message using the formats required by the IMS network. The SMS message may therefore need to be converted into a different format used by the mobile unit's home network.

The SMS message is received (at 705) by an S-CSCF and then conveyed (710) to the appropriate protocol dependent logic server (SIP PDLS) in the universal mobility manager (UMM). The SIP PDLS uses the SMS message to create a protocol-independent request message such as COPS message and then transmits (at 715) this message to the core logic server (CLS). The core logic server sends (at 720) a request for user information to the database function (DF), which uses this request to retrieve the appropriate information from a user profile and then returns (at 725) the requested information to the core logic server. The returned user profile information is then used to convert the original SMS message from the originating format into the destination format indicated by the profile information. The core logic server then sends (at 730) a request for message delivery along with the converted SMS message to the appropriate destination protocol dependent logic server (ANSI or UMTS PDLS).

The destination protocol dependent logic server can then forward (at 735) the converted SMS message to a mobility center or mobile switching center in the destination network. A confirmation is returned (at 740) to the protocol dependent logic server, which then acknowledges (at 745) the successful delivery of the converted SMS message. The core logic server sends (at 750) an acknowledgment to the source protocol dependent logic server, which forwards (at 755) a confirmation message such as a 200 OK message to the S-CSCF. The originating mobile terminal can then be contacted (at 760) to confirm that the SMS message was successfully transmitted to its destination.

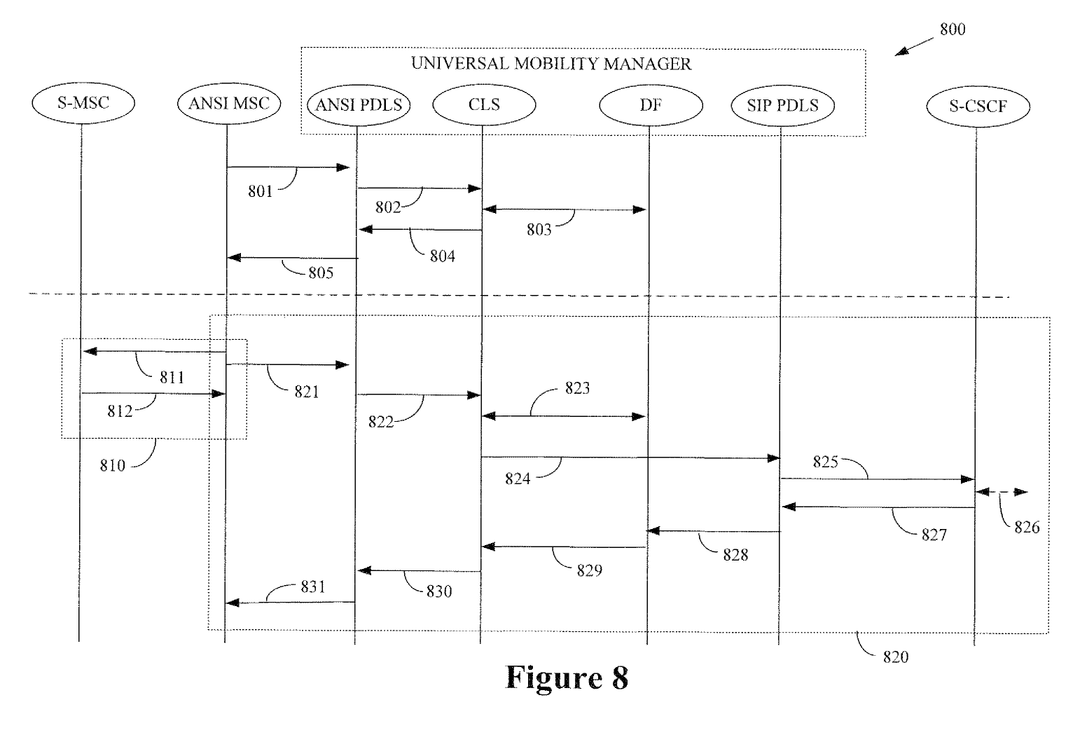

FIG. 8 conceptually illustrates one exemplary embodiment of a message flow 800 for delivery of a mobile-terminated SMS message. In the illustrated embodiment, the SMS message originates in an ANSI41 network or a UMTS network. The mobile unit that terminates the SMS message may however be located in a different type of network such as an IMS network. Consequently, the SMS message may have to be converted from the formats required by the originating network into a different format used by the terminating mobile unit at its current location. If the mobile unit is a multimode device that can roam between different network types, the format used for SMS messages by the terminating mobile unit may be different depending on whether it is in a home network or visiting some other type of network.

The location of the terminating mobile unit is determined in steps 801-805. In the illustrated embodiment, the SMS message originates in an ANSI network and so the mobile switching center (MSC) initially sends (at 801) the SMS message to a corresponding protocol dependent logic server (ANSI PDLS) in the universal mobility manager (UMM). The PDLS then sends (at 802) a protocol-independent request to the core logic server, which queries (at 803) the database function (DF) to gather information from the user profile associated with the terminating mobile unit. The core logic server returns (804) information indicating the destination address in the destination network indicated in the user profile. For example, if the server is roaming to a cellular network, an address of a mobile switching center in a cellular network may be returned (at 804). For another example, if the terminating mobile unit is roaming to an IMS network, an address of a home location register in the IMS network may be returned (at 804). The address information can then be forwarded (at 805) to the mobile switching center.

The message flow 800 proceeds as indicated in the box 810 when the terminating mobile unit is located in a cellular network. In the illustrated embodiment, the mobile switching center provides (at 811) the SMS message to a serving mobile switching center in the cellular network. The SMS message does not need to be converted in this case because the SMS message originated in a cellular network that uses the same formats. The serving mobile switching center can then acknowledge (at 812) receipt of the SMS message.

The message flow 800 proceeds as indicated in the box 820 when the terminating mobile unit is located in a network that uses different formats for the SMS message, such as an IMS network or a WiFi network. In the illustrated embodiment, the SMS message is forwarded (at 821) to the appropriate PDLS, which conveys (at 822) the SMS message to the core logic server along with a request to convert the SMS message to the format used by the destination network. The core logic server and the database function collaborate (at 823) to perform the requested conversion based upon information in a user profile associated with the terminating mobile unit. The core logic server then delivers (at 824) the converted SMS message along with a request to deliver this message to the appropriate PDLS associated with the destination network. The PDLS sends (at 825) the converted SMS message (e.g., as a SIP message) to a serving CSCF in the destination network for delivery (at 826) to the terminating mobile unit. The appropriate acknowledgments are then returned (at 827-831) to the entities along the communication pathway.

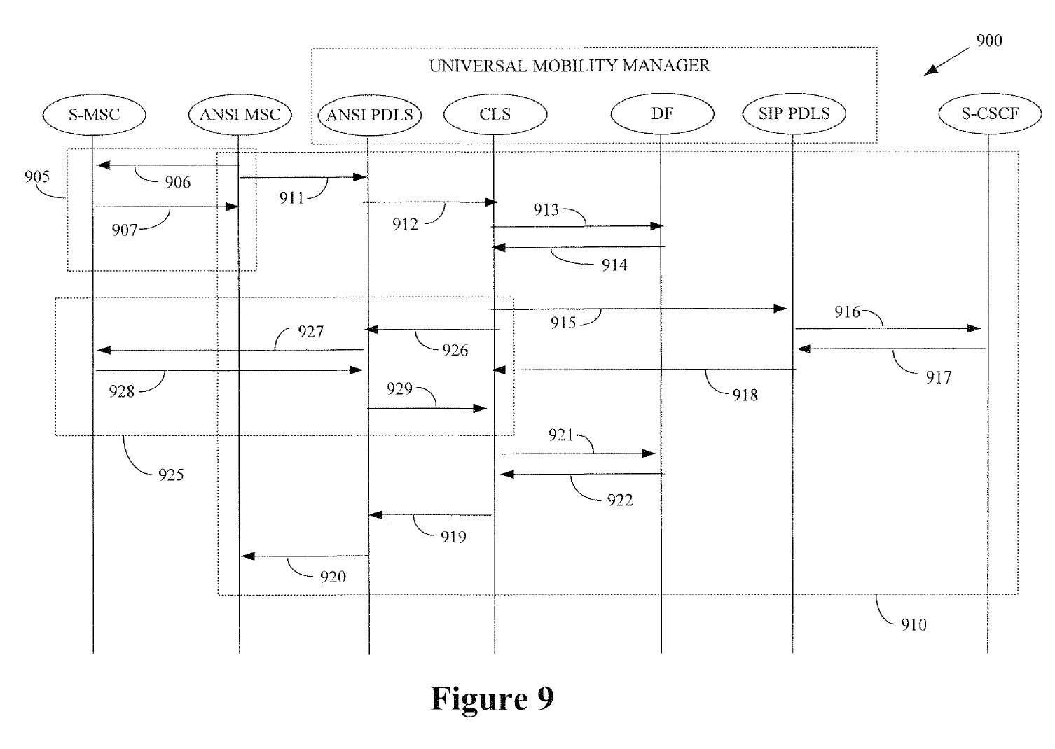

FIG. 9 conceptually illustrates one exemplary embodiment of a message flow 800 for delivery of a mobile-terminated SMS message to multiple destinations in multiple networks. In the illustrated embodiment, the SMS message originates in an ANSI41 network or a UMTS network. The mobile units that terminate the SMS message may however be located in a different type of network such as an IMS network and individual users may have specified multiple destination candidate networks in their profiles. Consequently, the SMS message may (or may not) have to be converted from the formats required by the originating network into a different format used by the terminating mobile unit at its current location. If the mobile unit is a multimode device that can roam between different network types, the format used for SMS messages by the terminating mobile unit may be different depending on whether it is in a home network or visiting some other type of network. Moreover, the multimode device may include multiple screens that use different formats for SMS messages depending on the network type that is used to provide connectivity to the different screens.

The message flow 900 proceeds as indicated in the box 905 when one of the terminating mobile units (or screens) is located in a cellular network. In the illustrated embodiment, the mobile switching center provides (at 906) the SMS message to a serving mobile switching center in the cellular network. The SMS message does not necessarily need to be converted in this case because the SMS message originated in a cellular network that uses the same formats. The serving mobile switching center can then acknowledge (at 907) receipt of the SMS message.

The message flow 900 proceeds as indicated in the box 910 when one or more terminating mobile units are located in a network that uses different formats for the SMS message, such as an IMS network or a WiFi network. In the illustrated embodiment, the SMS message is forwarded (at 911) to the appropriate PDLS, which conveys (at 912) the SMS message to the core logic server along with a request to convert the SMS message to the format used by the destination network. The core logic server and the database function collaborate (at 913, 914) to gather user information from the user profiles and perform the requested conversion based upon information in the user profile associated with each terminating mobile unit. The core logic server then delivers (at 915) the converted SMS message along with a request to deliver this message to the appropriate PDLS associated with the destination network. The PDLS sends (at 916) the converted SMS message (e.g., as a SIP message) to a serving CSCF in the destination network for delivery to the terminating mobile unit. The appropriate acknowledgments are then returned (at 917-920) to the entities along the communication pathway. If necessary, the core logic server can send (at 921) updated user information to the database function, which can use this information to update the user profiles and then return (at 922) an acknowledgment that the user information has been updated.

The message flow 900 may include additional messages indicated in the box 925 when the SMS message is to be delivered to a terminating mobile unit in the cellular network but there are also multiple destination candidates. In the illustrated embodiment, the core logic server transmits (at 926) the SMS message and a request to forward the message to the PDLS associated with the cellular network. This PDLS forwards (at 927) the short message in the appropriate format to mobile switching center. The appropriate acknowledgments are then returned to the PDLS and the core logic server (at 928, 929).

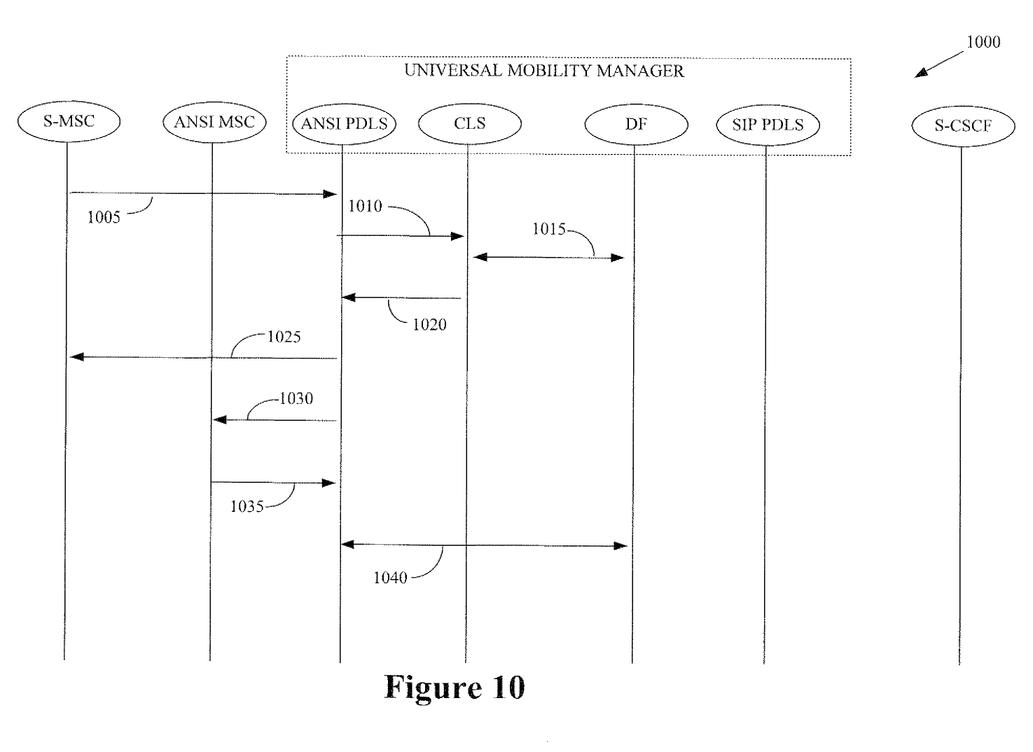

FIG. 10 conceptually illustrates one exemplary embodiment of a message flow 1000 that can be used to perform terminal status updates and alert short message service centers, e.g., during circuit roaming. In the illustrated embodiment, a mobile switching center transmits (at 1005) a registration notification to the appropriate protocol dependent logic server (PDLS) in the universal mobility manager (UMM). The registration notification can be used to update the location information associated with the user. For example, the registration notification may be transmitted in response to handover from one network to another, as well as in response to other changes in the present status, activity level (active, idle, dormant), or other changes in the status of the user. The PDLS uses the information in this registration notification to form a network protocol independent message that is transmitted (at 1010) to the core logic server, which collaborates (at 1015) with the database function to perform the requested update of the user profile. The core logic server then returns (at 1020) a message indicating that the requested update has been performed. The PDLS can provide (at 1025) an acknowledgment of the registration notification request to the serving mobile switching center. In one embodiment, the short message service center is alerted (at 1030) that the user profile and/or user location have been updated. The short message service center can then acknowledge (at 1035) receipt of the alert. The PDLS and the database function can exchange (at 1040) messages to confirm completion of the alert process and perform any necessary synchronization.

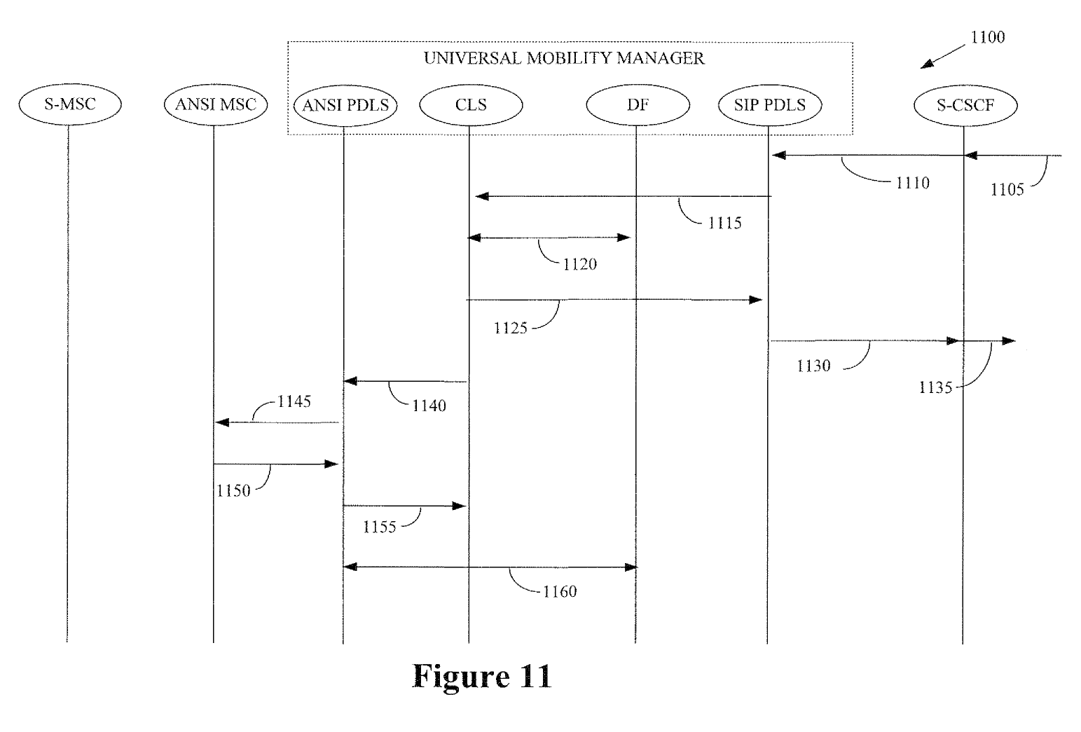

FIG. 11 conceptually illustrates one exemplary embodiment of a message flow 1100 that can be used to perform terminal status updates and alert short message service centers, e.g., during IMS roaming. In the illustrated embodiment, a S-CSCF receives (at 1105) a registration notification from a user and then forwards (at 1110) a SIP registration message to the appropriate protocol dependent logic server (PDLS) in the universal mobility manager (UMM). The registration message can be used to update the location information associated with the user. For example, the registration message may be transmitted in response to handover from one network to another or as part of an initial registration of the user, as well as in response to changes in the presence status, activity level (active, idle, dormant), or other changes in the status of the user. The PDLS uses the information in this registration notification to form a network protocol independent message that is transmitted (at 1115) to the core logic server, which collaborates (at 1120) with the database function to perform the requested update of the user profile. The core logic server then returns (at 1125) a message indicating that the requested update has been performed. The PDLS can provide (at 1130) an acknowledgment of the registration notification request to the serving mobile switching center, which can convey (at 1135) an acknowledgment to the user. In one embodiment, the short message service center is alerted (at 1140, 1145) that the user profile and/or user location have been updated. The alert may include a home location register address that is returned as a mobile switching center address in the case of an ANSI network. The short message service center can then acknowledge (at 1150) receipt of the alert. The PDLS may also acknowledge (at 1155) the alert. The PDLS and the database function can exchange (at 1160) messages to confirm completion of the alert process and perform any necessary synchronization.

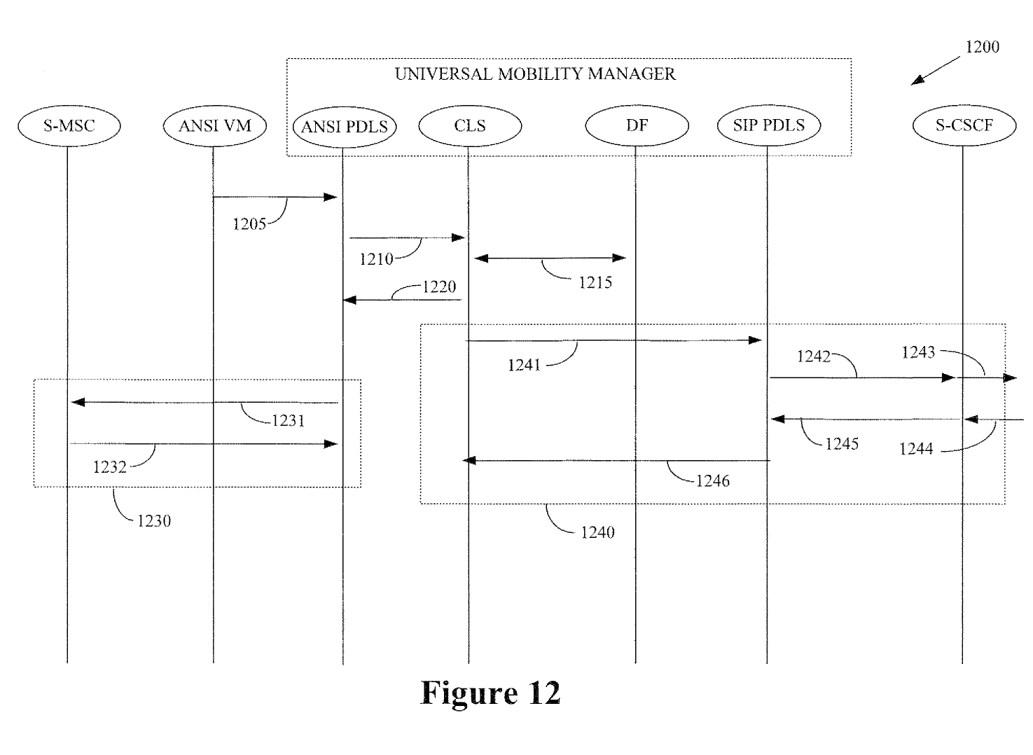

FIG. 12 conceptually illustrates one exemplary embodiment of a call flow for delivering a message waiting indicator using an SMS message. In the illustrated embodiment, the message waiting indicator is generated by a voicemail (VM) system and includes information that reports the current message count for the user. The voicemail system is located in an ANSI network that interfaces with the universal mobility manager through an ANSI PDLS. When the system wants to transmit a message waiting indicator, the voicemail system sends (at 1205) a message indicating the current message count to the PDLS, which uses this information to create a network protocol independent message that is transmitted (at 1210) to the core logic server. The core logic server and a database function collaborate (at 1215) to identify a profile associated with the user and to return information that can be used to identify the user's current network. This information is then returned (at 1220) to the PDLS and the voice mail system is notified (at 1225) that the user has been located.

When the user is roaming in an ANSI network the message flow 1200 proceeds as indicated in the box 1230. The voicemail system and the user's current network share the same format for SMS messages and so it may not be necessary to convert the message waiting indicator to a different format. The PDLS may therefore transmit (at 1231) the message waiting indicator to a serving mobile switching center in the ANSI network. The serving mobile switching center may then acknowledge (at 1232) receipt of the message waiting indicator. When the user is roaming in a different type of network such as an IMS network the message flow 1200 proceeds as indicated in the box 1240. The core logic server converts the original SMS message including the message waiting indicator from its original format into the format used in the destination network, which in this case is an IMS network. A network protocol independent message is used to convey (at 1241) the converted SMS message to the PDLS, which forwards (at 1242) the message waiting indicator (in the converted SMS message) to the S-CSCF for transmission (at 1243) to the roaming user. The appropriate acknowledgment can then be returned (at 1244-1246) to the S-CSCF, PDLS, and core logic server.

Embodiments of the universal mobility management features described herein have a number of advantages over the conventional practice. For example, the universal mobility manager can support local server look-up and so the SMS messages can be routed to maximize IP leg of Dynamic Server Assignment. The universal mobility manager also includes a presence detection mechanism that indicates user presence and supports location tracking and dynamic updates based upon roaming of the user. The universal mobility manager can be configured to implement dynamic circuit-switched Routing Number Interrogation based upon which technology the subscriber is roaming at a given point of time, e.g., using the information indicating the current network of the user. The PDLS and CLS interaction uses a common, protocol-independent efficient service logic that supports operations across different protocols and allows dynamic interworking decision-making across different protocols.

Users are also able to indicate priorities for different destinations (e.g., devices and/or screens) so that the universal mobility manager can provide efficient destination candidate selection based on DSP by prioritizing the destinations selection. Multiple levels of priorities can also be used. For example, if the user specifies the priorities ANSI41=1, UMTS=2, SIP=3, then UMTS is selected when ANSI is not available. For another example, if the user specifies the priorities ANSI41=1, UMTS=2-1, SIP=2-2, then UMTS and SIP are selected if the network supports forking. Otherwise UMTS is selected. Other dynamic destination selection criteria may include things like the time of day, a caller identifier, and the like.

The universal mobility manager also supports common APIs to both wireless and Internet users by implementing different PDLS entities for the different types of users. By limiting the need for inter carrier gateways, the universal mobility manager may reduce signaling for circuit/packet switching. Furthermore, IP leg of call can be minimized by optimizing the time of protocol selection of LTE, Mobility or IMS networks where subscriber is currently roaming.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
converting, at a mobility management entity, a short message service (SMS) message from a first format to at least one second format when at least one user profile stored in a database indicates that at least one destination of the SMS message uses said at least one second format.

2. The method of claim 1, wherein converting the SMS message comprises converting a text message of 140 octets or less.

3. The method of claim 1, wherein each user profile includes information indicating parameters used by a corresponding user for sending or receiving SMS messages.

4. The method of claim 3, wherein the parameters used by the corresponding user comprise at least one of a device or screen for sending or receiving SMS messages, a network type of the device or screen, a presence parameter for the device or screen, or a priority for sending or receiving SMS messages using the device or screen.

5. The method of claim 3, comprising modifying said at least one user profile based upon information provided the corresponding user or a home network of the corresponding user.

6. The method of claim 5, wherein modifying said at least one user profile comprises updating parameters in said at least one user profile in response to hand off of the corresponding user or a change in the activity or presence status of the user.

7. The method of claim 1, comprising receiving the SMS message at the mobility management entity in the first format and forming a query of the database based on the SMS message, the query requesting information from at least one user profile associated with at least one user indicated in the SMS message.

8. The method of claim 7, wherein receiving the SMS message comprises receiving a mobile-originated SMS message from a roaming user, querying the database to determine a home network of the roaming user, and converting the mobile-originated SMS message from a first format used by the roaming network to a second format used by the home network.

9. The method of claim 7, wherein receiving the SMS message comprises receiving a mobile-terminated SMS message destined for said at least one user, querying the database to determine at least one serving network for said at least one user, and converting the mobile-terminated SMS message from a first format of the received mobile-terminated SMS message to at least one second format used by said at least one serving network.

10. The method of claim 9, wherein receiving the SMS message comprises receiving a mobile-terminated SMS message destined for a plurality of users, querying the database to determine a plurality of serving networks for the users, and converting the mobile terminated SMS message from the first format to a plurality of second formats used by the plurality of serving networks.

11. The method of claim 1, wherein converting the SMS message comprises converting a SMS message including a message waiting indicator from a first format used by a voicemail system to said at least one second format.

12. The method of claim 1, wherein converting the SMS message comprises selecting at least one of a plurality of destinations for the SMS message, the destinations being indicated in the user profile.

13. The method of claim 12, wherein selecting said at least one of the plurality of destinations comprises selecting said at least one of the plurality of destinations based on at least one of a priority associated with each of the plurality of destinations or a presence indicator associated with each of the plurality of destinations, the priorities and presence indicators being included in the user profile.

14. A method, comprising:
accessing, at a mobility management entity, a short message service (SMS) message that conforms to a first format and is associated with a first user;
accessing a profile for the first user, the profile being stored in a database associated with the mobility management entity;
determining whether the SMS message is to be converted from the first format to a second format based on the profile; and
converting the SMS message to the second format when the profile indicates that the SMS message is to be converted.

15. The method of claim 14, wherein accessing the SMS message comprises receiving the SMS message using an interface of the mobility management entity that understands the first format and can form a query to the database using the first SMS message.

16. The method of claim 15, wherein accessing the profile for the first user comprises retrieving information from the profile using the query formed by the interface.

17. The method of claim 16, wherein retrieving the information from the profile comprises retrieving information indicating at least one of a device or screen for sending or receiving SMS messages, a network type of the device or screen, a presence parameter for the device or screen, or a priority for sending or receiving SMS messages using the device or screen.

18. The method of claim 14, wherein determining whether the SMS message is to be converted from the first format to the second format comprises comparing the first format to a second format indicated by information in the profile and determining that the SMS messages to be converted when the first format is different than the second format.

19. The method of claim 18, wherein determining whether the SMS message is to be converted from the first format to the second format comprises receiving a mobile-originated SMS message from a roaming user, querying the database to determine a home network of the roaming user, and determining that the mobile-originated SMS message is to be converted from a first format used by the roaming network to a second format used by the home network.

20. The method of claim 18, wherein determining whether the SMS message is to be converted from the first format to the second format comprises receiving a mobile-terminated SMS message destined for said at least one user, querying the database to determine at least one serving network for said at least one user, and converting the mobile-terminated SMS message from a first format of the received mobile-terminated SMS message to at least one second format used by said at least one serving network.

21. The method of claim 22, wherein determining whether the SMS message is to be converted from the first format to the second format comprises receiving a mobile-terminated SMS message destined for a plurality of users, querying the database to determine a plurality of serving networks for the users, and converting the mobile terminated SMS message from the first format to a plurality of second formats used by the plurality of serving networks.

22. The method of claim 14, wherein converting the SMS message comprises converting a SMS message including a message waiting indicator from a first format used by a voicemail system to said at least one second format.

23. The method of claim 14, wherein converting the SMS message comprises selecting at least one of a plurality of destinations for the SMS message, the destinations being indicated in the user profile.

24. The method of claim 23, wherein selecting said at least one of the plurality of destinations comprises selecting said at least one of the plurality of destinations based on at least one of a priority associated with each of the plurality of destinations or a presence indicator associated with each of the plurality of destinations, the priorities and presence indicators being included in the user profile.
